(19) United States
(12) Patent Application Publication
(10) Pub. No.: US 2017/0111838 A1
(43) Pub. Date: Apr. 20, 2017

(54) OFFLOADING MECHANISM USING LOAD-DEPENDENT OFFLOADING CRITERIA

(71) Applicant: Nokia Solutions and Networks Oy, Espoo (FI)

(72) Inventors: Claudio ROSA, Randers (DK); Daniela LASELVA, Klarup (DK); Klaus Ingemann PEDERSEN, Aalborg (DK); Hua WANG, Aalborg (DK)

(21) Appl. No.: 15/129,087

(22) PCT Filed: Mar. 28, 2014
(86) PCT No.: PCT/EP2014/056379

§ 371 Date: Sep. 26, 2016

(51) Int. Cl. H04W 36/22; H04W 48/18; H04W 36/00; H04W 36/14

(52) U.S. Cl. CPC H04W 36/22; H04W 36/14; H04W 48/18; H04W 36/0083

(57) ABSTRACT

Offloading Mechanism Using Load-Dependent Offloading Criteria Various communication systems may benefit from load adjustments, such as on-loading or off-loading. For example, third generation partnership project, 3GPP, and wireless local area network, WLAN, systems may benefit from a load-dependent load adjustment mechanism. A method can include obtaining (110), at a user equipment, at least one load-dependent criteria for load-adjusting. The interworking rule can relate to a mobile net work and a local area network. The method can also include applying (120), by the user equipment, the at least one load-dependent criteria when load-adjusting.

### BACKGROUND

Field

Various communication systems may benefit from load adjustments, such as on-loading or off-loading. For example, third generation partnership project (3GPP) and wireless local area network (WLAN) systems may benefit from an offloading mechanism using load-dependent offloading criteria.

Description of the Related Art

One area of 3GPP technology relates to radio enhancements to 3GPP/WLAN interworking to support operator assisted connectivity over WLAN along with user equipment (UE) predictability, cf. the 3GPP work item description RP-132101, which is hereby incorporated by reference.

In mobile communication networks, and especially in heterogeneous networks characterized by a macro cell over-layer and a small cell under-layer operating on different carrier frequencies, mobility/offloading decisions may need to be based not only on the terminal's radio channel conditions, but also on the load conditions in the source and/or potential target nodes.

The load conditions in the potential target nodes may be taken into account in the current 3GPP ideas for 3GPP/WLAN interworking. In detail, the UE can determine the availability of a WLAN access point (AP) depending on the WLAN AP load level, for example base station system (BSS) load and wide area network (WAN) metrics, in addition to WLAN radio signals. An available AP is conventionally expected to provide good enough quality if/when the UE offloads part of its traffic flows to it. 3GPP R2-140842, which is hereby incorporated herein in its entirety, provides examples of conventional criteria for 3GPP-to-WLAN offloading, such as Rsrp<threshRsrpLow or Rsrq<threshRsrqLow. Another example from that same document was bssLoad<threshBssLoadLow.

In such offloading/on-loading rules there is no dependency between, for example, the value of the load in the WLAN AP that is used to trigger the offload (onload) decision (e.g.

threshBssLoadLow) and the value of the corresponding RSRP/RSRQ thresholds (e.g. threshRsrpLow/threshRsrqLow and threshRsrpHigh/threshRsrqHigh).

In WLAN, broadcast of load information to assist AP selection by the WLAN devices is supported. This is because in WLAN there is typically no centralized controller, and load information needs to be exchanged “over the air” among different WLAN devices. For example, IEEE 802.11 specifies the advertising of several channel status/channel load/QoS information, as described below. The information is included in the Wi-Fi beacon and probe response frames of an AP.

This information includes BSS Average Access Delay IE, which refers to the average medium access delay for any transmitted frame measured from the time the frame is ready for until the actual frame transmission start time. The information also includes BSS AC Access Delay, which refers to, in QoS enabled APs (QAPs), average medium access delay for each of the indicated Access Categories defined by the IEEE 802.11e.

The information also includes BSS Load/QoS Basic Service Set (QBSS) Load Element IE, which includes the following fields: Station Count, which is the number of stations currently associated with the AP; Channel Utilization, which is the percentage of time that the AP senses the medium is busy; and Available Admission Capacity (AAC), which is the remaining amount of medium time available in units of 32 μs. AAC is derived from the Max RF Bandwidth configured under the Voice parameters for each network (802.11a/n and 802.11b/g/n).

In addition to the standardized QBSS field (IEEE 802.11e), there are proprietary versions of QBSS. One such version includes a Call Admission Limit value (defaults to 105 out of 255) instead of AAC.

The information also includes BSS Available Admission Capacity IE, which is 2+2+2*n bytes, containing the info of Admission Capabilities for each UP/AC (User Priority/Access Category). The information further includes QoS Traffic Capability IE, which is 2+1+m bytes, containing the info of STA counts for each UP/AC.

However, IEEE 802.11 does not specify how WLAN devices should use such information to determine to which AP they should attach to. Therefore, there is conventionally no possibility for the network to control to which small cell APs the mobile devices are connected.

Another option is to use an offloading booster, such that, if signaled by the radio access network (RAN) the offload preference indicator (OPI) indicates how aggressively the UE should use WLAN offload, with higher values indicating that the UE should use WLAN offload more aggressively. Nevertheless, the aggressiveness level defined by OPI is provided irrespective of the load conditions experienced in the target node.

Thus, with the offloading/on-loading thresholds and rules discussed above, there is no dependency between, for example the value of the load in the WLAN AP that is used to trigger the offload or onload decision and the value of the corresponding RSRP/RSRQ thresholds, OPI, etc.

### SUMMARY

According to certain embodiments, a method can include obtaining, at a user equipment, at least one load-dependent criteria for load-adjusting. The interworking rule can relate to a mobile network and a local area network. The method can also include applying, by the user equipment, the at least one load-dependent criteria when load-adjusting.

In certain embodiments, a method can include determining a desired level of aggressiveness when adjusting offloading and/or on-loading criteria for a user equipment depending on a load in a target and/or a source cell. The method can also include signaling a parameter configured to control the user equipment to apply the desired level of aggressiveness when adjusting the offloading and/or on-loading criteria between a source cell and a target cell depending on the load in at least one of said target and source cells.

A non-transitory computer-readable medium can, according to certain embodiments, be encoded with instructions that, when executed in hardware, perform a process. The process can be any of the above-described methods.

A computer program product can, in certain embodiments, encode instructions for performing a process. The process can be any of the above-described methods.

According to certain embodiments, an apparatus can include at least one processor and at least one memory including computer program code. The at least one memory and the computer program code can be configured to, with the at least one processor, cause the apparatus at least to obtain, at a user equipment, at least one load-dependent criteria for load-adjusting. The interworking rule can relate to a mobile network and a local area network. The at least one memory and the computer program code can also be configured to, with the at least one processor, cause the apparatus at least to apply the at least one load-dependent criteria when load-adjusting.

In certain embodiments, an apparatus can include at least one processor and at least one memory including computer program code. The at least one memory and the computer program code can be configured to, with the at least one processor, cause the apparatus at least to determine a desired level of aggressiveness when adjusting offloading and/or on-loading criteria for a user equipment depending on a load in a target cell and/or a source cell.

The at least one memory and the computer program code can also be configured to, with the at least one processor, cause the apparatus at least to signal a parameter configured to control the user equipment to apply the desired level of aggressiveness when adjusting the offloading and/or on-loading criteria between a source cell and a target cell depending on the load in at least one of said target and source cells.

An apparatus, according to certain embodiments, can include means for obtaining, at a user equipment, at least one load-dependent criteria for load-adjusting. The interworking rule can relate to a mobile network and a local area network. The apparatus can also include means for applying the at least one load-dependent criteria when load-adjusting.

An apparatus, in certain embodiments, can include means for determining a desired level of aggressiveness when adjusting offloading and/or on-loading criteria for a user equipment depending on a load in a target cell and/or a source cell. The apparatus can also include means for signaling a parameter configured to control the user equipment to apply the desired level of aggressiveness when adjusting the offloading and/or on-loading criteria between a source cell and a target cell depending on the load in at least one of said target and source cells.

### BRIEF DESCRIPTION OF THE DRAWINGS

For proper understanding of the invention, reference should be made to the accompanying drawings, wherein:

FIG. 1 illustrates a method according to certain embodiments.

FIG. 2 illustrates another method according to certain embodiments.

FIG. 3 illustrates a system according to certain embodiments.

### DETAILED DESCRIPTION

Certain embodiments may relate to radio communication system enhancements, such as enhancement of 3GPP rel-12 RAN/Wi-Fi interworking mechanisms. More particularly, in certain embodiments there can be a connection between the offloading/on-loading rules and the WLAN AP load level that is used to trigger the offload/onload decision. The rules can include, for example, threshold values, triggering criteria, and the like. Certain embodiments, in general, may provide a method and system to configure and signal load-dependent WLAN offloading/3GPP on-loading thresholds and/or criteria.

Certain embodiments may focus on the configuration and signaling by the 3GPP RAN of load adjustment rules, including rules regarding the off-loading from 3GPP to WLAN and on-loading from WLAN to 3GPP. The rules can include threshold values, triggering criteria, and the like, as mentioned above. These rules can be provided in connection with corresponding device load level. Specifically, in certain embodiments the load level in the source and/or target nodes/APs can be considered when performing decisions related to network selection and/or traffic steering, which involve the UE moving from or selecting between a source node and a target node across different systems, for example offloading from 3GPP to WLAN and/or on-loading from WLAN to 3GPP. For example, the lower the load level in the target cell and/or the higher the load level in the source cell, the more there can be a likelihood of selecting/handing over to the target node, potentially resulting in higher end user experience.

Certain embodiments can address a variety of scenarios. For example, certain embodiments can address a situation in which the UE is pre-provisioned with device level load-dependent 3GPP/WLAN radio interworking rules and/or thresholds. Certain embodiments can relate to a situation in which the rules are provided as part of the RAN assistance information. For example, the eNB can transfer to the UE a parameter that controls the device level load-dependent aggressiveness that the UE is to apply when evaluating the WLAN offloading rules. When performing offloading/onloading decisions to move part of traffic to/from WLAN/3GPP RAN, the UE can, in certain embodiments, apply the proper rules/recomputed parameters depending on the load information in the target cell. The UE can possibly consider the source cell as well.

Thus, certain embodiments link the device load level in the source and/or target nodes/APs, which is used to trigger the offload/onload decision, to the off-loading and on-loading rules, such as threshold values, triggering criteria, and the like. For example, certain embodiments provide, for WLAN capable devices, using load level in the nodes/APs to select an AP to attach to. Likewise, certain embodiments provide, for 3GPP RAN, configuring and signaling the off-loading and on-loading rules based on the load level in the source and/or target nodes/APs.

Accordingly, certain embodiments provide methods and systems to account for the load level in the source and/or target nodes/APs when performing decisions related to network selection and/or traffic steering which involve the UE moving between or selecting between a source and a target node across different systems. Such situations of UE movement or selection can include, for example, offloading from 3GPP to WLAN and/or on-loading from WLAN to 3GPP. Systems such as 3GPP and similar radio access networks can be referred to as mobile networks, while systems like WLAN and Wi-Fi can be referred as to as local area networks.

As mentioned above, in certain embodiments the user equipment can be configured such that the lower the load level in a target cell and/or the higher the load level in the source cell, the greater the likelihood of selecting or handing over to the target node.

In certain embodiments, as mentioned above, the UE can be pre-provisioned with load-dependent 3GPP/WLAN radio interworking rules and/or thresholds. The following are some not limiting examples of load-dependent rules and/or thresholds could be envisioned as follows. For example, one rule can be that the UE should (de-)boost AccessNetworkPriority parameter in the ANDSF based on the load level in the given access network. Another rule can be that the UE should decrease or increase threshRsrpLow and/or threshRsrqLow thresholds according to the load level in the target cell (WLAN AP). More specifically in a variation of this example rule, the UE should increase threshRsrpLow and/or threshRsrqLow thresholds if the load level in the given access network is high, and decrease them if the load is low.

In another example rule, the UE can also be instructed to decrease or increase threshRsrpHigh and/or threshRsrqHigh according to the load level in the source cell (WLAN AP). More specifically, in a variation of this rule, the UE should increase threshRsrpHigh and/or threshRsrqHigh thresholds if the load level in the given access network is low, and decrease them if the load is high. In a further rule, load-dependent RSRP and/or RSRQ thresholds (threshRsrpLow, threshRsrqLow, threshRsrpHigh and/or threshRsrqHigh) may be explicitly configured to be used when the load level in the WLAN AP is above and/or below specifically defined threshold values.

Those load-based rules could be pre-provisioned by a RAN and/or an enhanced ANDSF. Other ways of pre-provisioning the user equipment are also permitted.

In certain embodiments, as part of the RAN assistance information, the eNB can transfer to the UE, via broadcast or RRC signaling, one or more parameters configured to control the load-dependent level of aggressiveness that the UE is to apply when evaluating the WLAN offloading rules.

The parameter may be, for example, a dedicated parameter such as an Offload Booster Indicator (OBI). Alternatively, or in addition, an Offloading Preference Indicator (OPI) can be adapted to a similar purpose. In a further alternative, load-based offsets to be applied to the threshRsrpLow, threshRsrqLow, threshRsrpHigh and/or threshRsrqHigh thresholds could be sent. In the absence of such provided offsets, such thresholds may otherwise be set irrespective of the WLAN load level.

When performing offloading or onloading decisions to move part of the traffic to or from WLAN/3GPP RAN, the UE can apply the proper rules or recomputed parameters.

The application of the rules and/or parameters can depend on the load information in the target cell and possibly the source cell as well.

If no direct indication of the 3GPP load is provided to the UE, at least two levels of load could be inferred for the serving/target eNB: low vs. high or overload level. The high or overload level can be conditioned to the transmission by the eNB of an offloading indication via, for example, OPI, RSRP/RSRQ thresholds. In other words, a UE may infer that there is a high or overload situation, in view of the fact that the OPI or RSRP/RSRQ thresholds have been received.

Table 1 and Table 2 illustrate two possible implementations of certain embodiments.

TABLE 1
Example configuration of load-dependent
3GPP/WLAN radio interworking thresholds

| | | threshBssLoadLow < | |
|---|---|---|---|
| | bssLoad < | bssLoad < | bssLoad > |
| | threshBssLoadLow | threshBssLoadHigh | threshBssLoadHigh |
| threshRsrpLow | −80 dBm | −95 dBm | −120 dBm |
| threshRsrqLow | −10 dB | −12 dB | −14 dB |
| threshRsrpHigh | −60 dBm | −75 dBm | −95 dBm |
| threshRsrqHigh | −6 dB | −8 dB | −10 dB |

TABLE 2
Example configuration of load-dependent 3GPP/WLAN radio interworking rules

| | | threshBssLoadLow < | |
|---|---|---|---|
| | bssLoad < | bssLoad < | bssLoad > |
| | threshBssLoadLow | threshBssLoadHigh | threshBssLoadHigh |
| UE | (RSRQ < | (RSRQ < | (RSRQ < |
| connected | threshRsrqLow) | threshRsrqLow −· _{RSRQ}) | threshRsrqLow − |
| to 3GPP | AND/OR | AND/OR | N* · _{RSRQ}) |
| “offloads” | (RSRP < | (RSRP < | AND/OR |
| to WLAN if: | threshRsrpLow) | threshRsrpLow −· _{RSRP}) | (RSRP < |
| | | | threshRsrpLow − |
| | | | N* · _{RSRP}) |
| UE | (RSRQ > | (RSRQ > | (RSRQ > |
| connected | threshRsrqHigh) | threshRsrqHigh −· _{RSRQ}) | threshRsrqHigh − |
| to WLAN | AND/OR | AND/OR | N* · _{RSRQ}) |
| “on-loads” | (RSRP > | (RSRP > | AND/OR |
| to 3GPP if: | threshRsrpHigh) | threshRsrpHigh −· _{RSRP}) | (RSRP > |
| | | | threshRsrpHigh − |
| | | | N* · _{RSRP}) |

In certain embodiments as illustrated in Table 1, the UE can be explicitly configured with load-dependent RSRP and RSRQ thresholds. By contrast, in other certain embodiments illustrated in Table 2, the UE can be configured with load-dependent offsets, which can be added to the corresponding threshold values signaled by the network.

In an example possible implementation, the load-dependent thresholds and/or offsets can be provisioned to the UE from 3GPP RAN via system information block (SIB). For example, these thresholds and/or offsets can be broadcasted by a 3GPP node.

In yet another implementation, the 3GPP RAN may only broadcast one set of thresholds and/or offsets, while the load-dependent set of thresholds and/or offsets is signaled via radio resource control (RRC).

In another possible implementation, the default or broadcasted set of thresholds and/or offsets can also be used as load-specific setting in correspondence of a reference WLAN AP load. Such reference load again could be signaled by 3GPP RAN, via broadcast information or RRC signaling. Alternatively, the reference load can be predetermined by specifications.

Similarly, the load dependent offsets to be applied to RSRQ and RSRP measurement could either be explicitly signaled by 3GPP RAN (via broadcast information or RRC signaling) or fixed by specifications.

In yet another embodiment, the set of load-dependent thresholds and/or offsets signaled via RRC can completely overrule the default set of thresholds and/or offsets broadcasted by the 3GPP node.

In yet another embodiment, the 3GPP RAN can set specific load-dependent rules. For example, the RAN may not be limited to only using load-specific thresholds and/or offset. For instance, one non-limiting example is to use RSRQ-based offloading/on-loading in case of low load in WLAN AP and to use RSRP-based offloading/on-loading in case of high load in WLAN AP. Other similar embodiments are also possible.

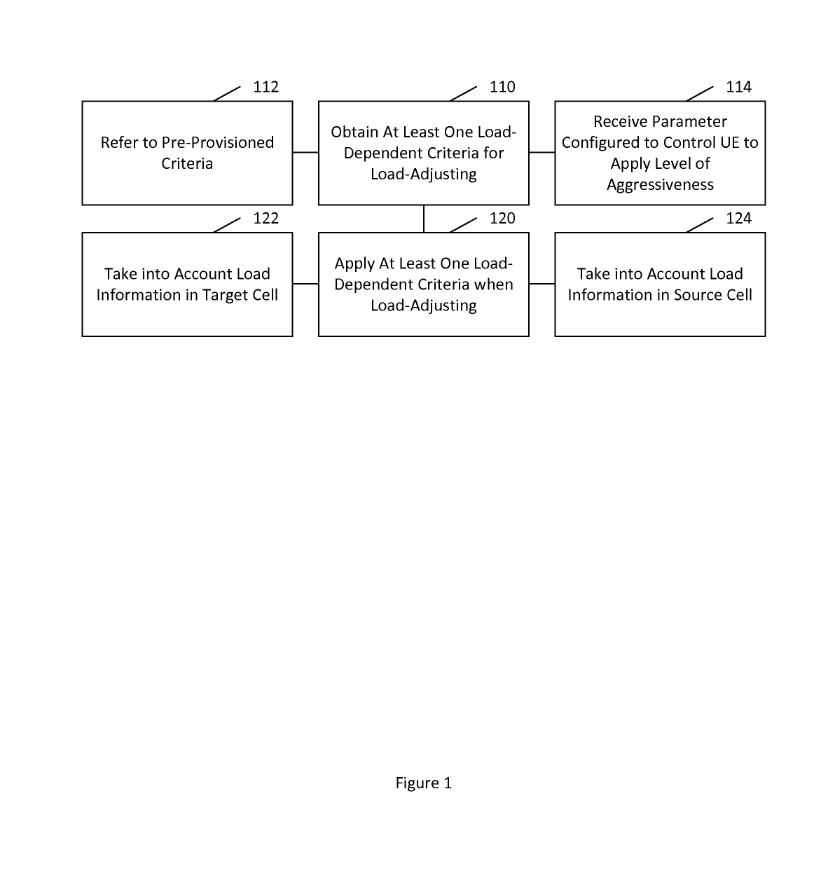

FIG. 1 illustrates a method according to certain embodiments. As shown in FIG. 1, a method can include, at 110, obtaining, at a user equipment, at least one load-dependent criteria for load-adjusting. The interworking rule can relate to a mobile network, such as a 3GPP network, and a local area network, such as a WLAN or Wi-Fi network.

The obtaining can include, at 112, referring to at least one pre-provisioned criteria, such as a pre-provisioned rule. The obtaining can also or alternatively include, at 114, receiving, from a network node, a parameter configured to control the user equipment to apply a desired level of aggressiveness when adjusting the offloading and/or on-loading criteria, wherein the adjusting the offloading criteria between said source and a target cells is controlled by the parameter. The parameter can include an offset to a pre-configured triggering threshold.

Load for at least one of the source cell or the target cell can be indicated indirectly by providing the parameter. Alternatively, load for at least one of the source cell or the target cell can be indicated directly by the corresponding cell.

The method can also include, at 120, applying, by the user equipment, the at least one load-dependent criteria when load-adjusting. The method can also include, at 122, taking into account load information in a target cell when selecting the offloading criteria from a source cell to a target cell. The method can further include, at 124, taking into account load information in the source cell when selecting the offloading criteria from the source cell to the target cell.

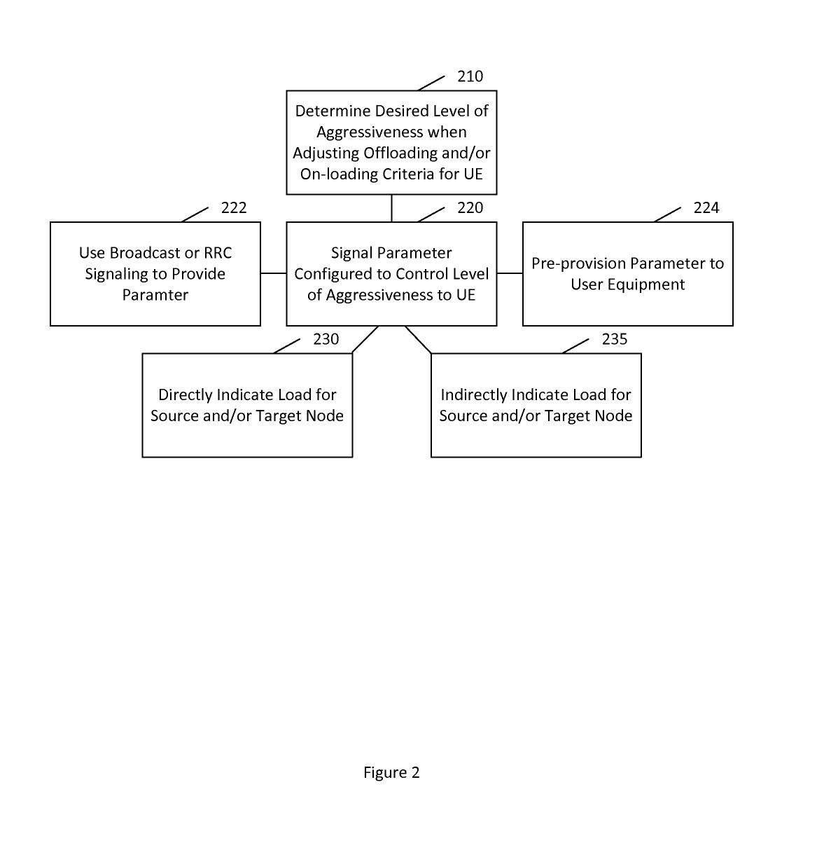

FIG. 2 illustrates another method according to certain embodiments. A method according to certain embodiments can include, at 210, determining a desired level of aggressiveness when adjusting offloading and/or on-loading criteria for a user equipment depending on a load in a target cell and/or a source cell. This determination can be based on a variety of factors, but may be based on an existing load of the network node, such as access point or base station, that makes the determination.

The method can also include, at 220, signaling a parameter configured to control the user equipment to apply the desired level of aggressiveness when adjusting the offloading and/or on-loading criteria between a source cell and a target cell depending on the load in at least one of said target and source cells.

The signaling can include the parameter is provided as part of radio access network assistance information, at 222, via broadcast or radio resource control signaling. Alternatively, the parameter can be provided, at 224, in a pre-provisioning of the user equipment.

The method can also include, at 230, directly indicating load for at least one of the source cell or the target cell. The method can further include, at 235, indirectly indicating load for at least one of the source cell or the target cell by providing the parameter.

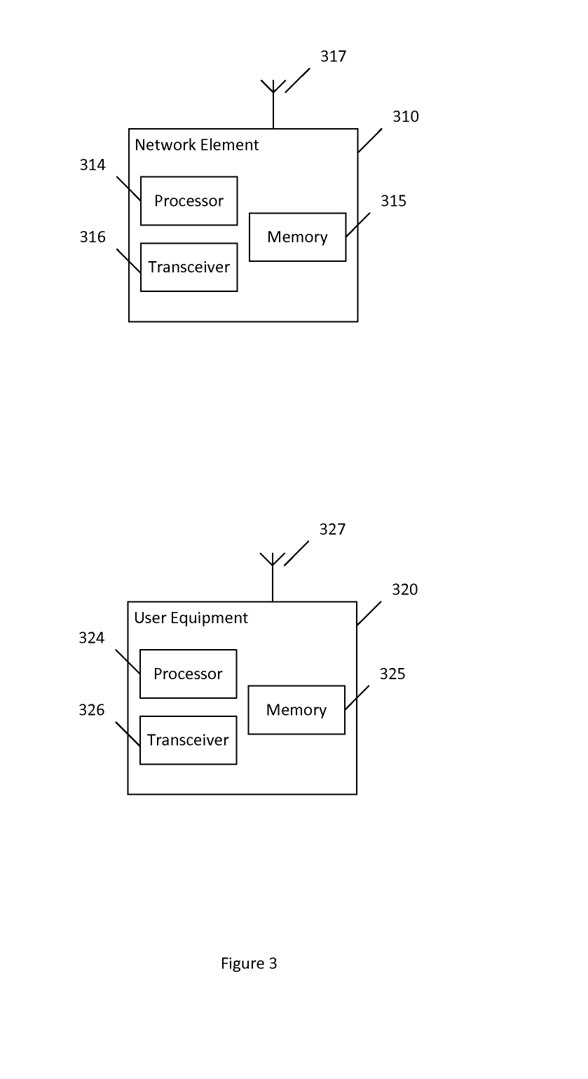

FIG. 3 illustrates a system according to certain embodiments. It should be understood that each block of the flowchart of FIG. 1 or 2 and any combination thereof may be implemented by various means or their combinations, such as hardware, software, firmware, one or more processors and/or circuitry. In one embodiment, a system may include several devices, such as, for example, network element 310 and user equipment (UE) or user device 320. The system may include more than one UE 320 and more than one network element 310, although only one of each is shown for the purposes of illustration. A network element can be an access point, a base station, an eNode B (eNB), server, host or any other network element discussed herein or the like. Each of these devices may include at least one processor or control unit or module, respectively indicated as 314 and 324. At least one memory may be provided in each device, and indicated as 315 and 325, respectively. The memory may include computer program instructions or computer code contained therein. One or more transceiver 316 and 326 may be provided, and each device may also include an antenna, respectively illustrated as 317 and 327. Although only one antenna each is shown, many antennas and multiple antenna elements may be provided to each of the devices. Other configurations of these devices, for example, may be provided. For example, network element 310 and UE 320 may be additionally configured for wired communication, in addition to wireless communication, and in such a case antennas 317 and 327 may illustrate any form of communication hardware, without being limited to merely an antenna. Likewise, some network elements 310 may be solely configured for wired communication, and in such cases antenna 317 may illustrate any form of wired communication hardware, such as a network interface card.

Transceivers 316 and 326 may each, independently, be a transmitter, a receiver, or both a transmitter and a receiver, or a unit or device that may be configured both for transmission and reception. The transmitter and/or receiver (as far as radio parts are concerned) may also be implemented as a remote radio head which is not located in the device itself, but in a mast, for example. The operations and functionalities may be performed in different entities, such as nodes, hosts or servers, in a flexible manner. In other words, division of labor may vary case by case. One possible use is to make a network element deliver local content. One or more functionalities may also be implemented as virtual application(s) in software that can run on a server.

A user device or user equipment 320 may be a mobile station (MS) such as a mobile phone or smart phone or multimedia device, a computer, such as a tablet, provided with wireless communication capabilities, personal data or digital assistant (PDA) provided with wireless communication capabilities, portable media player, digital camera, pocket video camera, navigation unit provided with wireless communication capabilities or any combinations thereof.

In an exemplary embodiment, an apparatus, such as a node or user device, may include means for carrying out embodiments described above in relation to FIG. 1 or 2.

Processors 314 and 324 may be embodied by any computational or data processing device, such as a central processing unit (CPU), digital signal processor (DSP), application specific integrated circuit (ASIC), programmable logic devices (PLDs), field programmable gate arrays (FPGAs), digitally enhanced circuits, or comparable device or a combination thereof. The processors may be implemented as a single controller, or a plurality of controllers or processors.

For firmware or software, the implementation may include modules or unit of at least one chip set (for example, procedures, functions, and so on). Memories 315 and 325 may independently be any suitable storage device, such as a non-transitory computer-readable medium. A hard disk drive (HDD), random access memory (RAM), flash memory, or other suitable memory may be used. The memories may be combined on a single integrated circuit as the processor, or may be separate therefrom. Furthermore, the computer program instructions may be stored in the memory and which may be processed by the processors can be any suitable form of computer program code, for example, a compiled or interpreted computer program written in any suitable programming language.

The memory or data storage entity is typically internal but may also be external or a combination thereof, such as in the case when additional memory capacity is obtained from a service provider. The memory may be fixed or removable.

The memory and the computer program instructions may be configured, with the processor for the particular device, to cause a hardware apparatus such as network element 310 and/or UE 320, to perform any of the processes described above (see, for example, FIGS. 1 and 2). Therefore, in certain embodiments, a non-transitory computer-readable medium may be encoded with computer instructions or one or more computer program (such as added or updated software routine, applet or macro) that, when executed in hardware, may perform a process such as one of the processes described herein. Computer programs may be coded by a programming language, which may be a high-level programming language, such as objective-C, C, C++, C#, Java, etc., or a low-level programming language, such as a machine language, or assembler. Alternatively, certain embodiments of the invention may be performed entirely in hardware.

Furthermore, although FIG. 3 illustrates a system including a network element 310 and a UE 320, embodiments of the invention may be applicable to other configurations, and configurations involving additional elements, as illustrated and discussed herein. For example, multiple user equipment devices and multiple network elements may be present, or other nodes providing similar functionality, such as nodes that combine the functionality of a user equipment and an access point, such as a relay node. The UE 320 may likewise be provided with a variety of configurations for communication other than communication network element 310. For example, the UE 320 may be configured for device-to-device communication.

Certain embodiments may have various benefits and/or advantages. For example, certain embodiments may provide that the UE is served by the network/cell which experiences a lower load condition. This selection may result in a larger fraction of resources available for the UE and therefore further result in a higher end user experience.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

### PARTIAL GLOSSARY

ANDSF Access Network Discovery and Selection Function

AP Access point

CA Carrier aggregation

CAC Composite available capacity

eNB enhanced NodeB

HO Handover

Load-adjusting Off-loading, On-loading, or both

MIB Master information block

MLB Mobility load balancing

MRO Mobility robustness optimization

PBCH Physical broadcast channel

PRACH Physical random access channel

PRB Physical resource block

QoS Quality of service

RLF Radio link failure

RRC Radio resource control

RRH Radio remote head

RRM radio resource management

RSRP Reference signal received power

RSRQ Reference signal received quality

RSSI Received signal strength indication

SIB System information block

SON Self optimizing networks

UE User equipment

1-43. (canceled)

44. A method, comprising:
obtaining, at a user equipment, at least one load-dependent criteria for offloading the user equipment from a source cell to a target cell, wherein the criteria is relates to a mobile network and a local area network; and
applying, by the user equipment, the at least one load-dependent criteria when load-adjusting.

45. The method of claim 44, wherein load for at least one of the source cell or the target cell is indicated directly by the corresponding cell.

46. The method of claim 44, wherein the obtaining comprises referring to at least one pre-provisioned criteria.

47. The method of claim 44, wherein the obtaining comprises receiving, from a network node, a parameter configured to control the user equipment to apply a desired level of aggressiveness when adjusting the offloading criteria between a source and a target cell depending on the load in at least one of said target and source cells, wherein the adjusting the offloading criteria between said source and a target cells is controlled by the parameter.

48. The method of claim 47, wherein the parameter comprises an offset to a pre-configured triggering threshold.

49. The method of claim 47, wherein load for at least one of the source cell or the target cell is indicated indirectly by providing the parameter.

50. The method of claim 44, further comprising:
taking into account load information in a target cell when selecting the offloading criteria from a source cell to a target cell.

51. An apparatus, comprising:
at least one processor; and
at least one memory including computer program code,
wherein the at least one memory and the computer program code are configured to, with the at least one processor, cause the apparatus at least to:
obtain, at the apparatus, at least one load-dependent criteria for load-adjusting, wherein the criteria is relates to a mobile network and a local area network; and
apply the at least one load-dependent criteria when load-adjusting.

52. The apparatus of claim 51, wherein load for at least one of the source cell or the target cell is indicated directly by the corresponding cell.

53. The apparatus of claim 51, wherein the at least one memory and the computer program code are configured to, with the at least one processor, cause the apparatus at least to:
obtain the at least one load-dependent criteria by referring to at least one pre-provisioned criteria.

54. The apparatus of claim 51, wherein the at least one memory and the computer program code are configured to, with the at least one processor, cause the apparatus at least to:
obtain the at least one load-dependent criteria by receiving, from a network node, a parameter configured to control the apparatus to apply a desired level of aggressiveness when adjusting the offloading criteria between a source and a target cell depending on the load in at least one of said target and source cells, wherein adjusting the offloading criteria between said source and a target cells is controlled by the parameter.

55. The apparatus of claim 54, wherein the parameter comprises an offset to a pre-configured triggering threshold.

56. The apparatus of claim 54, wherein load for at least one of the source cell or the target cell is indicated indirectly by providing the parameter.

57. The apparatus of claim 51, wherein the at least one memory and the computer program code are configured to, with the at least one processor, cause the apparatus at least to:
take into account load information in a target cell when selecting the offloading criteria from a source cell to a target cell.

58. The apparatus of claim 57, wherein the at least one memory and the computer program code are configured to, with the at least one processor, cause the apparatus at least to:
take into account load information in the source cell when selecting the offloading criteria from the source cell to the target cell.

59. An apparatus, comprising:
at least one processor; and
at least one memory including computer program code,
wherein the at least one memory and the computer program code are configured to, with the at least one processor, cause the apparatus at least to
determine a desired level of aggressiveness when adjusting offloading and/or on-loading criteria for a user equipment depending on a load in a target cell and/or a source cell; and
signal a parameter configured to control the user equipment to apply the desired level of aggressiveness when adjusting the offloading and/or on-loading criteria between a source cell and a target cell depending on the load in at least one of said target and source cells.

60. The apparatus of claim 59 wherein the parameter is provided as part of radio access network assistance information via broadcast or radio resource control signaling.

61. The apparatus of claim 59, wherein the parameter is provided in a pre-provisioning of the user equipment.

62. The apparatus of claim 59, wherein the at least one memory and the computer program code are configured to, with the at least one processor, cause the apparatus at least to:
directly indicate load for at least one of the source cell or the target cell.

63. The apparatus of claim 59, wherein the at least one memory and the computer program code are configured to, with the at least one processor, cause the apparatus at least to:
indirectly indicate load for at least one of the source cell or the target cell by providing the parameter.
